(19) United States
(12) Patent Application Publication
(10) Pub. No.: US 2004/0073428 A1
(43) Pub. Date: Apr. 15, 2004

(54) Apparatus, methods, and programming for speech synthesis via bit manipulations of compressed database

(76) Inventors: Igor Zlokarnik, Natick, MA (US); Laurence S. Gillick, Newton, MA (US); Jordan R. Cohen, Gloucester, MA (US)

Correspondence Address: Edward W. Porter, Porter & Associates, Suite 600, One Broadway, Cambridge, MA, 02142, US

(21) Appl. No.: 10/268,612

(22) Filed: Oct. 10, 2002

(51) Int. Cl. G10L 13/08

(52) U.S. Cl. 704/260

(57) ABSTRACT

Text-to-speech synthesis modifies the pitch of the sounds it concatenates to generate speech, when such sounds are in compressed, coded form, so as to make them sound better together. The pitch, duration, and energy of such concatenated sounds can be altered to better match, respectively, pitch, duration, and/or energy contours generated from phonetic spelling of the speech to be synthesized, which can, in turn, be derived from the text to be synthesized. The synthesized speech can be generated from the encoded sound of sub-word snippets as well as of one or more whole words. The duration of concatenated sounds can be changed by inserting or deleting sound frames associated with individual snippets. Such text-to-speech can be used to say words recognized by speech recognition, such as to provide feedback on the recognition. Such text-to-speech synthesis can be used in portable devices such as cellphones, PDAs, and/or wrist phones.

### FIELD OF THE INVENTION

The present invention relates to apparatus, methods, and programming for synthesizing speech.

### BACKGROUND OF THE INVENTION

Speech synthesis systems have matured recently to such a degree that their output has become virtually indistinguishable from natural speech. These systems typically concatenate short samples of prerecorded speech (snippets) from a single speaker to synthesize new utterances. At the adjoining edges of the snippets, speech modifications are applied in order to smooth out the transition from one snippet to the other. These modifications include changes to the pitch, the waveform energy (loudness), and the duration of the speech sound represented by the snippets.

Any such speech modifications normally incur some degradation in the quality of the speech sound produced. However, the amount of speech modifications necessary can be limited by choosing snippets that originated from very similar speech contexts. The larger the amount of prerecorded speech, the more likely the system will find snippets of speech for concatenation that share similar contexts and thus require relatively little speech modification, if any at all. Therefore, the most naturally sounding systems utilize databases of tens of hours of prerecorded speech.

Server applications of speech synthesis (such as query systems for flight or directory information) can easily cope with the storage requirements of large speech databases. However, severe storage limitations exist for small embedded devices (like cellphones, PDAs, etc.). Here, compression schemes for the speech database need to be employed.

A natural choice are vocoders (short for “voice coders/decoders”) since they have been particularly tailored to the compression of speech signals. In addition, some embedded devices, most notably digital cellphones, already have vocoders resident. Using a compressed database, speech synthesis systems simply decompress the snippets in a preprocessing function and subsequently proceed with the same processing functions as in the uncompressed scheme, namely speech modification and concatenation.

This established technique has been widely successful in a number of applications. However, it is important to note that it relies on the fact that access to the snippets is available after they have been decompressed. Unfortunately, numerous embedded platforms exist where this access is not available, or is not easily available, when using the device's resident vocoder. Because of their high computational load, vocoders typically run on a special-purpose processor (a so-called digital signal processor) that communicates with the main processor. Communication with the vocoder is not always made completely transparent for general-purpose software such as speech synthesis software.

### SUMMARY OF THE INVENTION

The present invention eliminates the need for the speech synthesis system to retrieve snippets after the decompression function. Rather than decompressing the data as the first function, the invention decompresses the data as the last function. This way, the vocoder can send its output along its regular communication path straight to the loudspeakers. The functions of speech modification and concatenation are now performed upfront upon the encoded bitstream.

Vocoders employ a mathematical model of speech, which allows for control of various speech parameters, including those necessary for performing speech modifications: pitch, energy, and duration. Each control parameter gets encoded with various numbers of bits. Thus, there is a direct relationship between each bit in the bitstream and the control parameters of the speech model. A complete set of encoded parameters forms a packet. Concatenation of a series of packets corresponds to concatenation of different snippets in the decompressed domain. Thus, both functions of speech modification and concatenation can be performed by systematic manipulation of the bitstream without having to decompress it first.

### DESCRIPTION OF THE DRAWINGS

These and other aspects of the present invention will become more evident upon reading the following description of the preferred embodiments in conjunction with the accompanying drawings, in which:

FIG. 1 illustrates an embodiment of the invention in which its synthesized speech is used in conjunction with playback of prerecorded LPC encoded phrases to provide feedback to a user of voice recognition name dialing software on a cellphone;

FIG. 2 is a highly schematic representation of the major components of the cellphone on which some embodiments of the present invention are used;

FIG. 3 is a highly schematic representation of some of the programming and data structures that can be stored on the mass storage device of a cellphone in some embodiments of the present invention;

FIG. 4 is a highly simplified pseudocode description of programming for creating a sound snippet database that can be used with the speech synthesis of the present invention;

FIG. 5 is a schematic representation of the recording of speech sounds used in conjunction with the programming described in FIG. 4;

FIG. 6 is a schematic representation of how speech sounds recorded in FIG. 5 can be time aligned against phonetic spellings as described in FIG. 4;

FIG. 7 is a schematic representation of processes described in FIG. 4, including the encoding of recorded sound into a sequence of LPC frames and then dividing that sequence of frames into a set of encoded sound snippets corresponding to diphones;

FIG. 8 illustrates the structure of an LPC frame encoded using the EVRC encoding standard;

FIG. 9 is a highly simplified pseudocode description of programming for performing code snippet synthesis and modification according to the present invention;

FIG. 10 is a highly schematic representation of the operation of a pronunciation guesser, which produces a phonetic spelling for text provided to it as an input;

FIG. 11 is a highly schematic representation of the operation of a prosody module, which produces duration, pitch, and energy contours for a phonetic spelling provided to it as an input;

FIG. 12 is a schematic representation of how the programming shown in FIG. 9 accesses a sequence of diphone snippets corresponding to a phonetic spelling and synthesizes them into a sequence of LPC frames;

FIG. 13 is a schematic representation of how the programming of FIG. 9 modifies the sequence of LPC frames generated as shown in FIG. 12, so as to correct its duration, pitch, and energy to better match the duration, pitch, and energy contours created by the prosody module illustrated in FIG. 11.

### DESCRIPTION OF ONE OR MORE PREFERRED EMBODIMENTS OF THE INVENTION

Vocoders differ in the specific speech model they use, how many bits they assign to each control parameter, and how they format their packets. As a consequence, the particular bit manipulations required for performing speech modifications and concatenation in the vocoded bitstream depend upon the specific vocoder being used.

The present invention will be illustrated for the particular choice of an Enhanced Variable Rate Codec (EVRC) as specified by the TIA/EIA/IS-127 Interim Standard of January 1997, although virtually any other vocoder could be used with the invention.

The EVRC codec uses a speech model based on linear prediction, wherein the speech signal is generated by sending a source signal through a filter. In terms of speech production, the source signal can be viewed as the signal originating from the glottis, while the filter can be viewed as the vocal tract tube that spectrally shapes the source signal. In the EVRC, the filter characteristics are controlled by 10 so-called line spectral pair frequencies. The source signal typically exhibits a periodic pulse structure during voiced speech and random characteristics during unvoiced speech. In the EVRC, the source signal s[n] gets created by combining an adaptive contribution a[n] and a fixed contribution f[n] weighted by their corresponding gains, gainₐ and gain_{f} respectively:

s[n]=gainₐ a[n]+gain_{f} f[n]

In the EVRC the gainₐ can be as high as 1.2, and the gain_{f} can be as high as several thousand.

The adaptive contribution is a delayed copy of the source signal:

a[n]=s[n−T]

The fixed contribution is a collection of pulses of equal height with controllable signs and positions in time. During highly periodic segments of voiced speech, the adaptive gain takes on values close to 1 while the fixed gain approaches 0. During highly aperiodic sounds, the adaptive gain approaches values of 0, while the fixed gain will take on much higher values. Both gains effectively control the energy (loudness) of the signal, while the delay T helps to control the pitch.

The codec communicates each packet at one of three rates corresponding to 9600 bps, 4800 bps, and 1200 bps. Each packet corresponds to a frame (or speech segment) of 160 A/D samples taken at a sampling rate of 8000 samples per second. Each frame corresponds to 1/50 of a second.

Each frame is further broken down into 3 sub-frames of sizes 53, 53, and 54 samples respectively. Only one delay T and one set of 10 line spectral pairs is specified across all 3 sub-frames. However, each sub-frame gets its own adaptive gain, fixed gain, and set of 3 pulse positions and their signs assigned. The delay T and the line spectral pairs model period pitch and formants which can be modeled fairly accurately with parameter settings every 1/50 second. The adaptive gain, fixed gain, and set of 3 pulse positions are varied more rapidly to allow the system to better model the more complex residual excitation function.

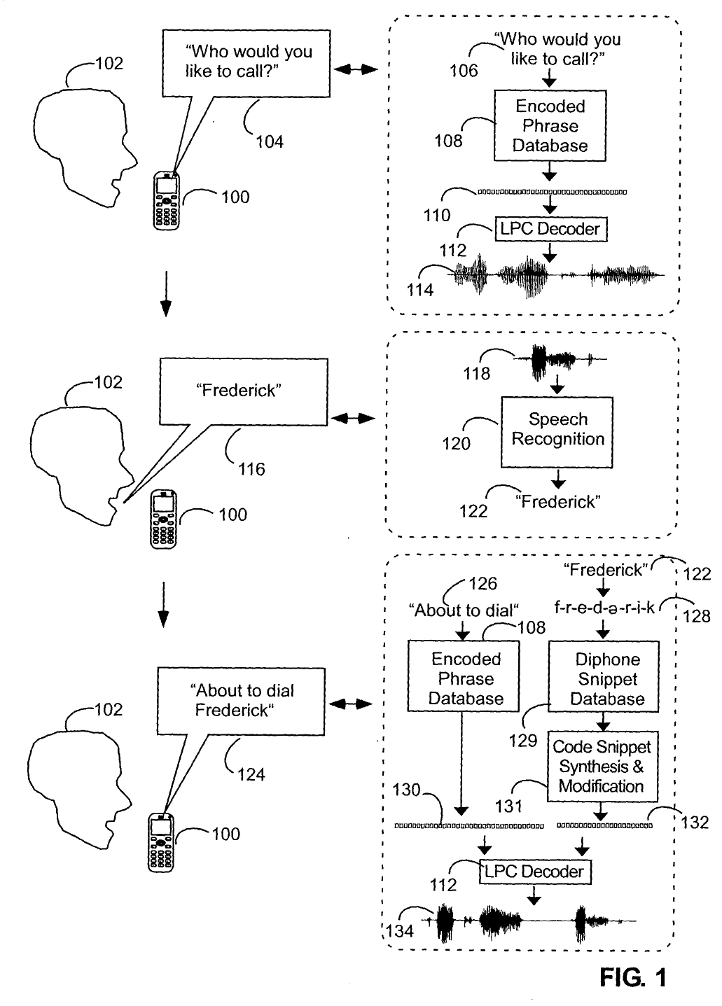

FIG. 1 illustrates one type of embodiment, and one type of use, of the present invention. In this embodiment the invention is used in a cellphone 100 which has a speech recognition name dialing feature. The invention's text-to-speech synthesis is used to provide voice feedback to the user confirming whether or not the cellphone has correctly recognized a name the user wants to dial.

In the embodiment shown in FIG. 1 when the user 102 enters a name dial mode, the cellphone 100 gives him a text-to-speech prompt 104 which asks him who he wishes to dial. An identification of the prompt phrase 106 is used to access from a database of linear predictive coded phrases 108 an encoded sequence of LPC frames 110 that represent a recording of an utterance of the identified phrase. This sequence of LPC frames is then supplied to an LPC decoder 112 to produce a cellphone quality waveform 114 of a voice saying the desired prompt phrase. This waveform is played over the cellphone's speaker to create the prompt 104.

In this embodiment the encoded phrase database 108 stores an encoded recording of entire commonly used phrases, so that the playback of such phrases will not require any modifications of the type that commonly occur in text-to-speech synthesis, and so that the playback of such phrases will have a relatively natural sound. In other embodiments encoded words or encoded sub-word snippets of the type described below could be used to generate prompts.

When the user responds to the prompt 104 by speaking the name of a person he would like to dial, as indicated by the utterance 116, the waveform 118 produced by its utterance is provided to a speech recognition algorithm 120. This algorithm selects the name it considers to most likely match the utterance waveform.

The embodiment of FIG. 1 responses to the recognition of a given name by producing a prompt 124 to inform the user that it is about to dial the party whose name has just been recognized. This prompt includes the concatenation of a pre-recorded phrase 126 and the recognized name 122. A sequence 130 of encoded LPC frames is obtained from the encoded phrase database 108 that corresponds to an LPC encoded recording of the phrase 126. A phonetic spelling 128 corresponding to the recognized word 122 is applied to a diphone snippet database 129. As will be explained in more detail below, the diphone snippet database includes an LPC encoded recording of each possible diphone, that is, each possible sequence of two phonemes from the set of all phonemes in the languages being supported by the system.

In response to the phonetic spelling 128 a sequence of diphones corresponding to the phonetic spelling are supplied to a code snippet synthesis and modification algorithm 131. This algorithm synthesizes a sequence of LPC frames 132 that corresponds to the sequence of encoded diphone recordings received from the database 129, after modification to cause those coded recordings to have more natural pitch, energy, and duration contours. The LPC decoder 112 is used to generate a waveform 134 from the combination of the LPC encoded recording of the fixed phrase 126 and the synthesized LPC recorded representation of the recognized name 122. This produces the prompt 124 that provides feedback to the user, enabling him or her to know if the system has correctly recognized the desired name, so the user can take corrective action in case it has not.

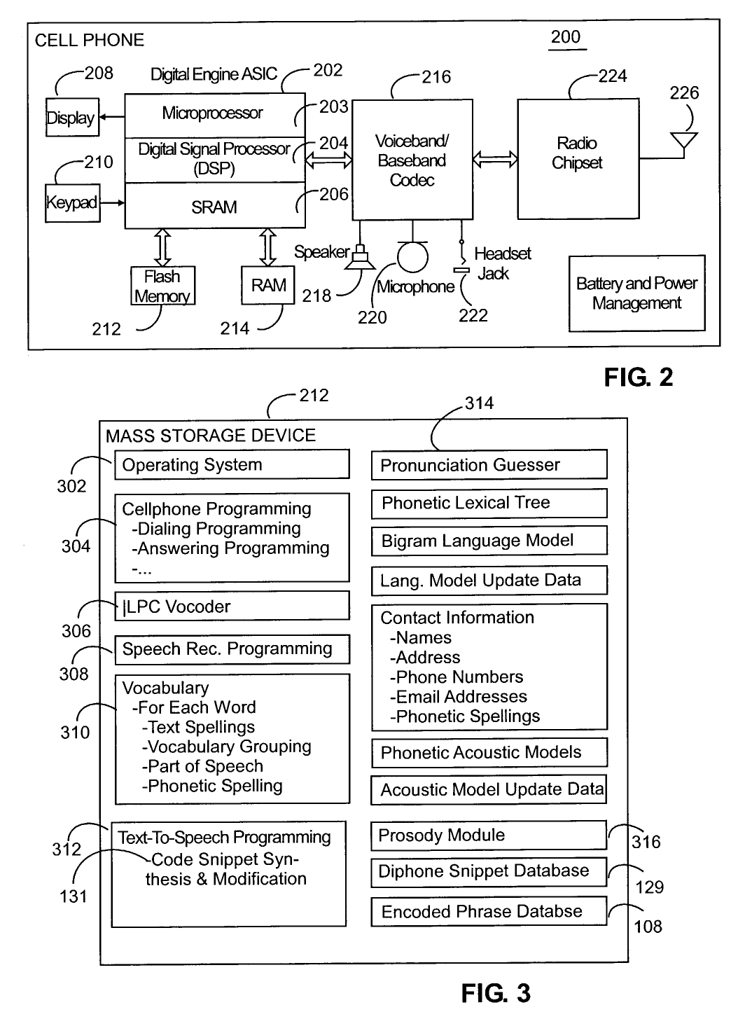

FIG. 2 is a highly schematic representation of a cellphone 200. The cellphone includes a digital engine ASIC 202, which includes a microprocessor 203, a digital signal processor, or DSP 204, and SRAM 206. The ASIC 202 can drive the cellphone's display 208 and receive input from the cellphone's keyboard 210. The ASIC is connected so that it can read information from and write information to a flash memory 212, which acts as the mass storage device of the cellphone. The ASIC is also connected to a certain amount of random access memory or RAM 214, which is used for more rapid and more short-term storage and reading of programming and data.

The ASIC 202 is connected to a codec 216 that can be used in conjunction with the digital signal processor to function as an LPC vocoder, that is, a device that can both encode and decode LPC encoded representations of recorded sound. Cellphones encode speech before transmitting it, and decode speech encoded transmissions received from other phones, using one or more different LPC vocoders. In fact, most cellphones are capable of using multiple different LPC vocoders, so that they can send and receive voice communications with other cellphones that use different cellphone standards.

The codec 216 is connected to drive the cellphones speaker 218 as well as to receive a user's utterances from a microphone 220. The codec is also connected to a headset jack 222, which can receive speech sounds from a headset microphone and output speech sounds to a headset earphone.

The cellphone 200 also includes a radio chipset 224. This chipset can receive radio frequency signals from an antenna 226, demodulate them, and send them to the codec and digital signal processor 204 for decoding. The radio chipset can also receive encoded signals from the codec 216, modulate them on an RF signal and transmit them over the antenna 226.

FIG. 3 illustrates some of the programming and data structures that are stored in the cellphone's mass storage device. In the embodiment shown in FIG. 2 the mass storage device is the flash memory 212. In other cellphones other types of mass storage devices, including other types of nonvolatile memory, and small hard disks could be used instead.

The mass storage device 212 includes an operating system 302 and programming 304 for performing normal cellphone functions such as dialing and answering the phone. It also stores LPC vocoder software 306 for enabling the digital signal processor 204 and the codec 216 to convert audio waveforms into encoded LPC representations and vice versa.

In the embodiment shown, the mass storage device stores speech recognition programming 308 for recognizing words said by the cellphone's user, although it should be understood that the voice synthesis of the current invention can be used without speech recognition. It also stores a vocabulary 310 of words. The phonetic spellings which this vocabulary associates with its words can be used both by the speech recognition programming 308 and by text-to-speech programming 312 that is also located on the mass storage device.

The text-to-speech programming 312 includes the code snippet synthesis and modification programming 131 described above with regard to FIG. 1. It also uses the encoded phrase database 108 and the diphone snippet database 129 described above with regard to FIG. 1.

The mass storage device also stores a pronunciation guessing module 314 that can be used to guess the phonetic spelling of words that are not stored in the vocabulary 310. This pronunciation guesser can be used both in speech recognition and in text-to-speech generation.

The mass storage device also stores a prosody module 316, which is used by the text-to-speech generation programming to assign pitch, energy, and duration contours to the synthesized waveforms produced for words or phrases so as to cause them to have pitch, energy, and duration variations more like those such waveforms would have if produced by a natural speaker.

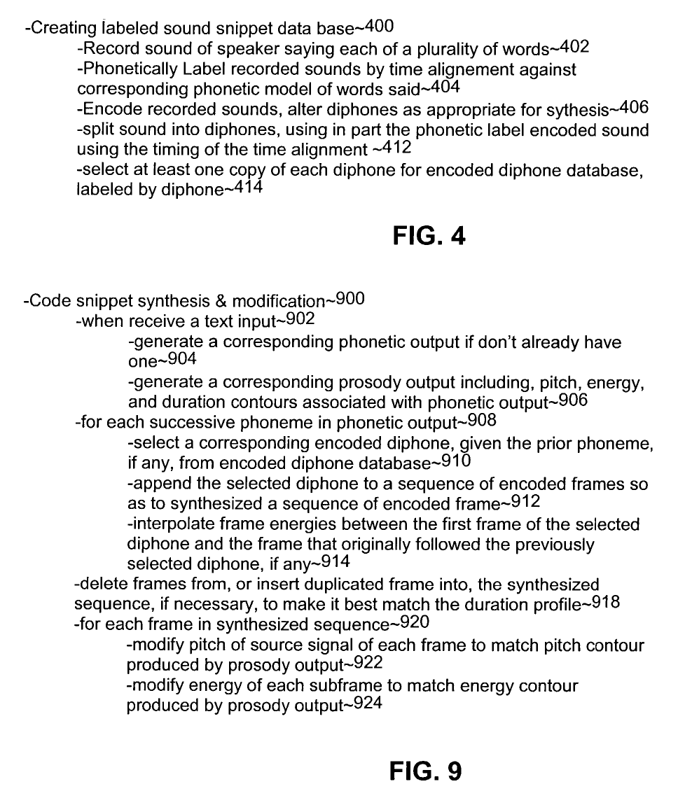

FIG. 4 is a highly simplified pseudocode description of programming 400 for creating a phonetically labeled sound snippet data base, such as the diphone snippet database 129 described above with regard to FIG. 1. Commonly this programming will not be performed on the individual device performing synthesis, but rather be performed by one or more computers at a software company providing the text-to-speech capability of the present invention.

The programming 400 includes a function 402 for recording the sound of speaker saying each of a plurality of words from which the diphone snippet database can be produced. In some embodiment this function will be replaced by use of a pre-recorded utterances database.

FIG. 5 is a schematic illustration of this function. It shows a human speaker 500 speaking into a microphone 502 so as to produce waveforms 504 representing such utterances. Analog to digital conversion and digital signal processing converts the waveforms 504 into sequences 510 of acoustic parameters 508, which can be used by the phonetic labeling function 404 described next.

Function 404 shown in FIG. 4 phonetically labels the recorded sounds produced by function 402. It does this by time aligning phonetic model of the recorded words against such recording.

This is illustrated in FIG. 6. This figure shows a given sequence 510 of parameter frames 508 that corresponds to the utterance of a sequence of words. It also shows a sequence of phonetic models 600 that corresponding to the phonetic spellings 602 of the sequence of words 604 in the given sequence of parameter frames. This sequence of phonetic models is matched against the given sequence of parameter frames. A probabilistic sequence matching algorithm, such as Hidden Markov modeling, is used to find an optimal match between the sequence of parameter frame models 606 of the sequence of phonetic model 600 and the sequence of parameter frames 508 of each utterance.

Once such an optimal match has been found various portions of each parameter frames sequence 510 will be mapped against different phonemes 608 as indicated by the brackets 610 near the bottom FIG. 6. Once such labeling has been performed, the start and end time of each such phoneme's corresponding portion of the parameter frames sequence 510 can be calculated, since each parameter frame in the sequence has a fixed, known duration. These phoneme start and end times can also be used to map the phonemes 608 against corresponding portions of the waveform representation 504 of the utterance represented by the frames sequence 510.

Once utterances of words have been time aligned as shown in FIG. 6, function 406 of FIG. 4 encodes the recorded sounds, using LPC encoding and altering diphones as appropriate for the invention's speech synthesis. In the embodiment shown this encoding uses EVRC encoding, of the type described above.

The standard EVRC encoding is modified slightly in the current embodiment by preventing any adaptive gain value from being greater than one, as will be described below.

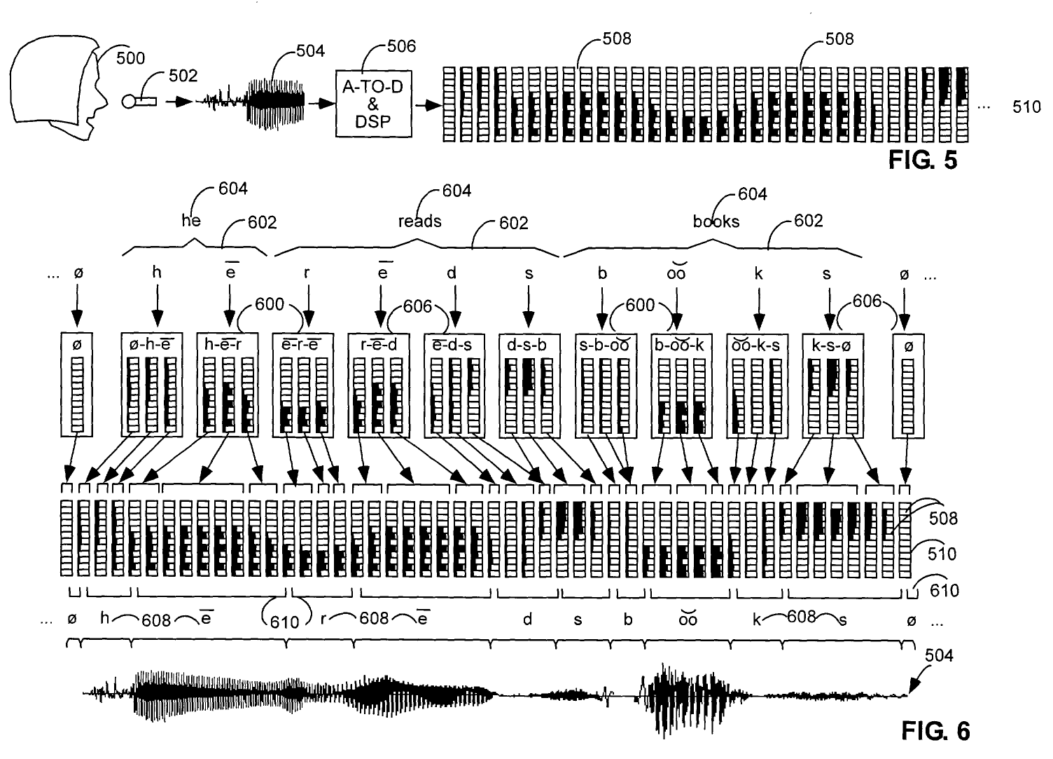

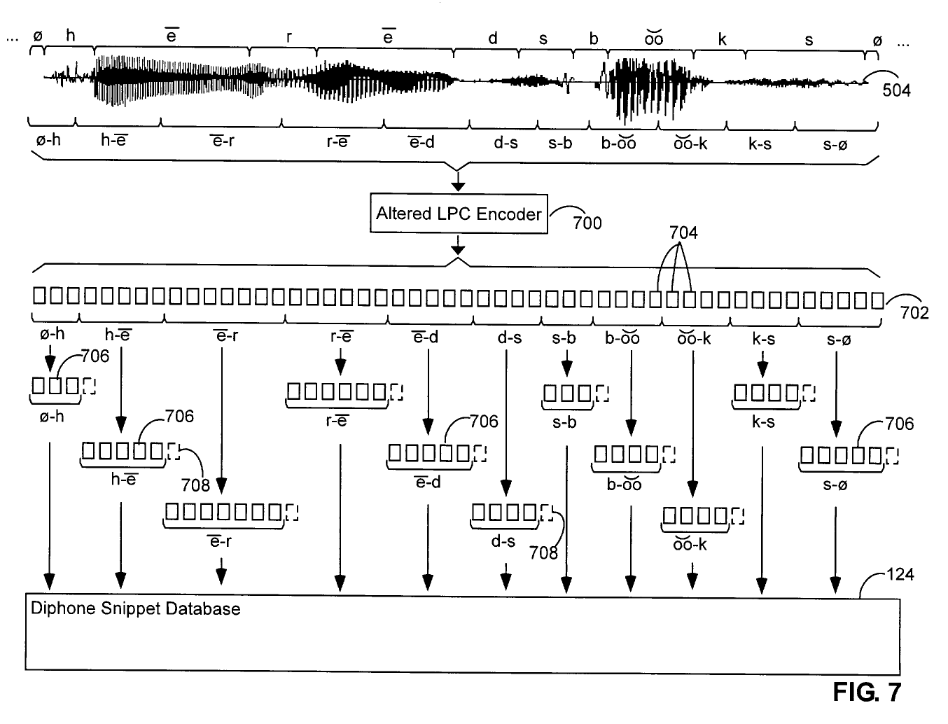

FIG. 7 illustrates functions 406 through 414 of FIG. 4. It shows the waveform 504 of an utterance with the phonetic labeling produced by the time alignment process described above with regard to FIG. 6. It also shows the LPC encoding operations 700 which are performed upon the waveform 504 to produce a corresponding sequence 702 of encoded LPC frames 704.

Once an utterance has been encoded by the LPC encoder, function 412 of FIG. 4 splits the resulting sequence of LPC frames 704 into a plurality of diphones 706. The process of splitting the LPC frames in the diphones uses the time alignment of phonemes produced by function 404 to help determine which portions of the encoded acoustic signal correspond to which phonemes. Then one of various different processes can be used to determine how to split the LPC frames sequence into sub-sequences of frames that correspond to diphones.

In the current embodiment the process of dividing LPC frames into diphone sub-sequences seeks to label as a diphone a portion of the LPC frame sequence ranging from approximately the middle of one phoneme to the middle of the next. The splitting algorithm also seeks to place the split in a portion of each phoneme in which the phoneme's sound is varying the least. In other embodiment other algorithms for splitting the frame sequence into diphones could be used. In still other embodiment the LPC frames sequence can be divided into other sub-word phonetic units beside diphones, such as frames sequences representing single phonemes, each in the context of their preceding and following phoneme, or frames sequences that represented syllables, or three or more successive phonemes.

Once the LPC frames sequence corresponding to an utterance has been split into diphones, function 414 of FIG. 4 selects at least one copy of each diphone 706, shown in FIG. 7, for the diphone snippet database 129.

As indicated in FIG. 7 when each diphone snippet 706 is stored in a diphone snippet database it is stored with the gain values 708, including both the adaptive and fixed gain values, associated with the LPC frame following the last LPC frame corresponding to the diphone in the utterance from which it has been taken. As will be explained below, these gain values 708 are used to help interpolate energies between diphone snippet's to be concatenated.

In the current embodiment of the invention the diphone snippet database stores only one copy of the each possible diphone. This is done to reduce the memory space required to store that database. In other embodiment of the invention in which memory is not so limited multiple different versions can be stored for each diphone, so that when a sequence of diphone snippet are being synthesized, the synthesizing program will be able to choose from among a plurality of snippets for each diphone, so as to be able to select a sequence of snippets that best fit together.

The function of recording the diphone snippet database only needs to be performed once during creation of the system and is not part of its normal deployment. In the embodiment being described, the LPC encoding used to create the diphone snippet database is the EVRC standard. In order to increase the compression ratio of the speech database, we force the encoder to use the rate of 4800 bps only. In the embodiment being described, we use this middle EVRC compression rate both to reduce the amount of space required to store the diphone snippet database and because the modifications which are required when the diphone snippets are synthesized in the speech segments reduce their audio quality sufficiently, that the higher recording quality afforded by the 9600 bps EVRC recording rate would be largely wasted.

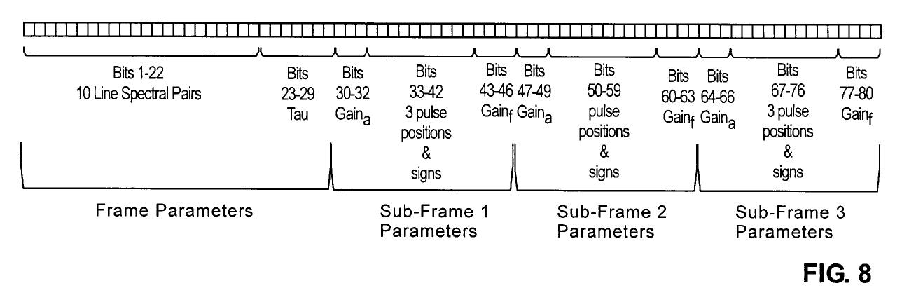

At the 4800 bps rate, each of the 50 packets produced a second contains 80 bits. As is illustrated in FIG. 8 these 80 bits are allocated to the various speech model parameters as follows: 10 line spectral pair frequencies (bits 1-22), 1 delay (bits 23-29), 3 adaptive gains (bits 30-32, 47-49, 64-66), 3 fixed gains (bits 43-46, 60-63, 7780), 9 pulse positions and their signs (bits 33-42, 50-59, 67-76).

FIG. 9 provides a highly simplified pseudo code description of the code snippet synthesis and modification programming 131 described above with regard to FIGS. 1 and 3.

Function 902 responds to the receipt of a text input that is to be synthesized by causing functions 904 and 906 to be performed. Function 904 uses a pronunciation guessing module 314, of the type described above with regard to FIG. 3, to generate a phonetic spelling of the received text, if the system does not already have such a phonetic spelling.

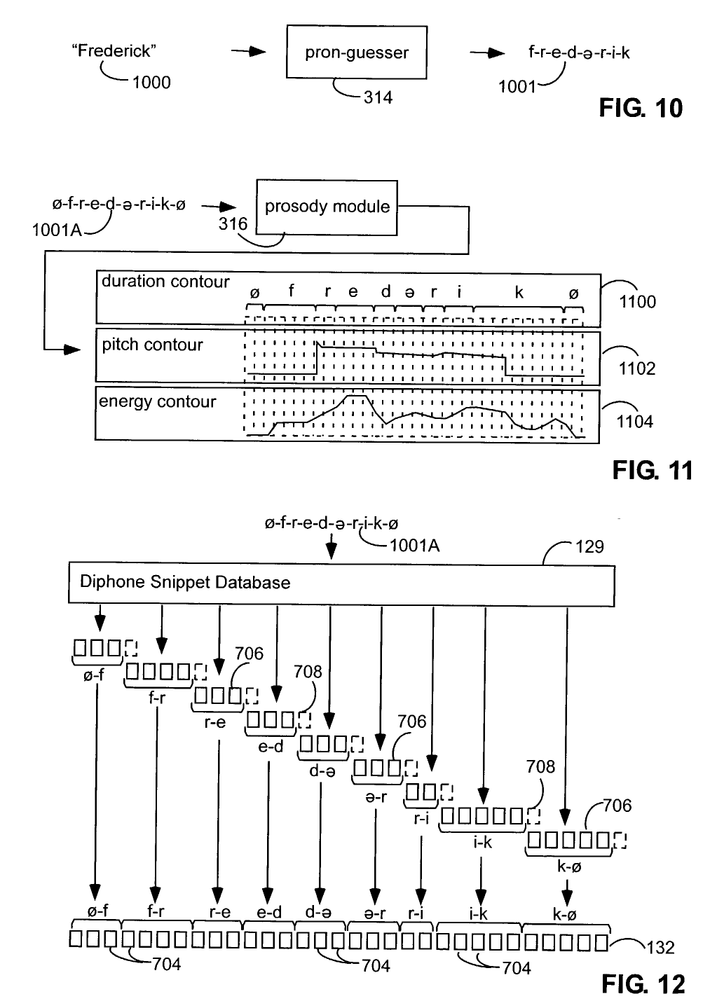

This is illustrated schematically in FIG. 10, in which, according to the example described above with regard to FIG. 1, the received text is the word “Frederick” 1000. This name is applied to the pronunciation guessing algorithm 314 to produce the corresponding phonetic spelling 1001.

Once the algorithm of FIG. 9 has a phonetic spelling for the word to be generated, function 906 generates a corresponding prosody output, including pitch, energy, and duration contours associated with the phonetic spelling.

This is illustrated schematically in FIG. 11, in which the phonetic spelling 1001 shown in FIG. 10, after having a silence phoneme added before and after it, is applied to the prosody module 316 described above briefly with regard to FIG. 3. This prosody module produces a duration contour 1100 for the phonetic spelling, which indicates the amount of time that should be allocated to each of its phonemes in a voice output corresponding to the phonetic spelling. The prosody module also creates a pitch contour 1102, which indicates the frequency of the periodic pitch excitation which should be applied to various portions of the duration contour 1100. In FIG. 11 the initial and final portions of the pitch contour have a pitch value of 0. This indicates that the corresponding portions of the voice output to be created do not have any periodic voice excitation of the type normally associated with pitch in a human-like voice. Finally the prosody module also creates an energy contour 1104, which indicates the amount of energy, or volume, to be associated with the voice output produced for various portions of the duration contour 1100 associated with the phonetic spelling 1001A.

The algorithm of FIG. 9 includes a loop 908 performed for each successive phoneme in the phonetic spelling 1001A for which a voice output is to be created. Each such loop comprises functions 910 through 914.

For each successive phoneme in the phonetic spelling, function 910 selects a corresponding encoded diphone snippet 706 from the diphone snippet database 129, as is shown in FIG. 12. Each such successively selected diphone snippet corresponds to two phonemes, the phoneme of the prior iteration of the loop 908, and the phoneme of the current iteration of that loop. Although it is not shown in FIG. 9, in the embodiment shown, no diphone snippet is selected in the first iteration of this loop.

In embodiments of the invention where more than one diphone snippet is stored for a given diphone, function 910 will select for a given phoneme pair the corresponding diphone snippet that minimizes a predefined cost function. Commonly this cost function would penalize choosing snippets that would result in abrupt changes in the LPC parameters at the concatenation points. This comparison can be performed between the immediately adjacent frames to the snippets in their original context and the ones in their new context. The cost function thereby favors choosing snippets that originated from similar, if not identical, contexts.

Function 912 appends each selected diphone snippet into a sequence of encoded LPC frames 704 so as to synthesize a sequence 132 of encoded frames, shown in FIG. 12, that can be decoded to represent the desired sequence of speech sounds.

Function 914 interpolates frame energies between the first frame of the selected diphone snippet and the frame that originally followed the previously selected diphone snippet, if any.

This is done because the frame energies of a given snippet A affect the frame energies of a given snippet B that follows it in the sequence 132 of LPC frames being synthesized. This is because the adaptive gain causes energy contributions to be copied from snippet A's frames into snippet B's frames. At their concatenation point, snippet A's frame energy will typically be different from the frame energy that preceded snippet B in its original context. In order to reduce the affect on snippet B's frame energies, we interpolate both the adaptive and fixed gain values of snippet B's first frame with those of the frame that immediately followed snippet A in its original context, as stored in the energy value 708 at the end of each diphone snippet. This includes interpolating the adaptive and fixed gains in each of the first, second, and third sub-frames from the frame that followed snippet A in its original context, as stored in the energy value parameter set 708, respectively, with the adaptive and fixed gains in each of the first, second and third sub-frames of the first frame of snippet B.

As was described above with regard to function 406 of FIG. 4, the LPC encoding used to create the diphone snippets prevents the encoder from having any adaptive gain values in excess of 1. This is done in order to ensure that discrepancies in frame energies will eventually decay rather than get amplified by succeeding snippets.

In the embodiment being described the algorithm of FIG. 9 does not take any steps to interpolate between line spectral pair values at the boundaries between the diphone snippets because the EVRC decoder algorithm itself automatically performs such interpolation.

Once an initial sequence of frames 132, as shown at the bottom of FIG. 12, corresponding to the diphones to be spoken has been synthesized, function 918 of FIG. 9 deletes frames from, or insert duplicated frame into, the synthesized LPC frame sequence, if necessary, to make it best match the duration profile that has been produced by function 906 for the utterance to be generated.

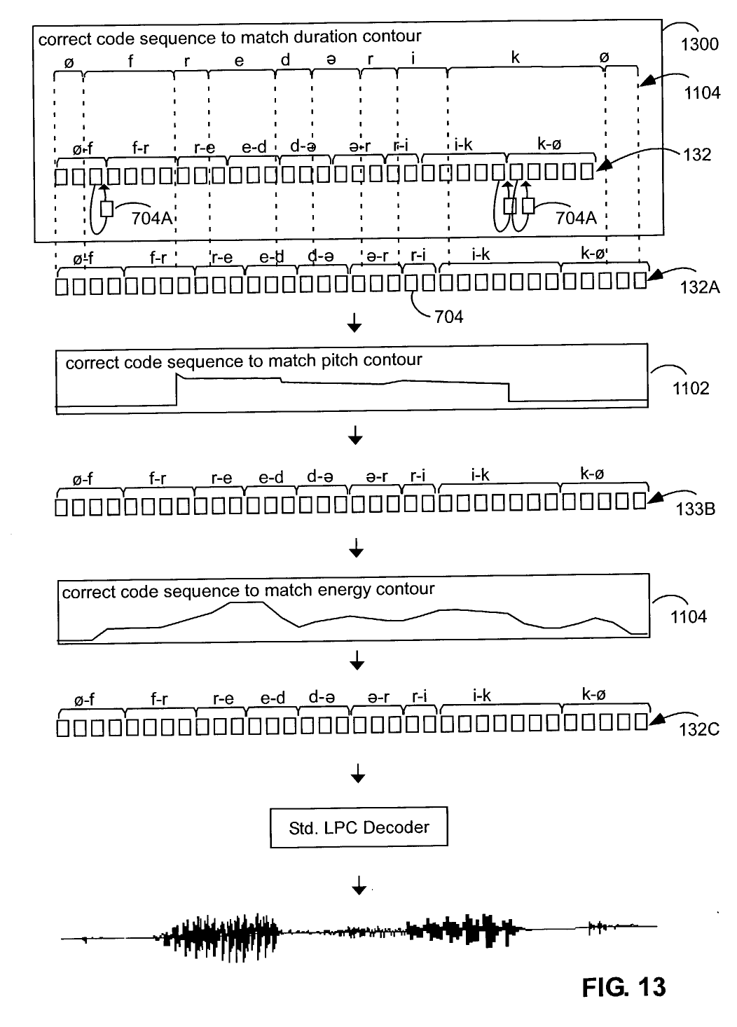

This is indicated graphically in FIG. 13 in the portion of that figure enclosed in the box 1300. As shown in this figure the sequence 132 of LPC frames that has been directly created by the synthesis shown in FIG. 12 is compared against the duration contour 1104. In the case of the example the only changes in duration are the insertion of duplicate frames 704A into the sequence 132 so it will have the increased length shown in the resulting frame sequence 132A.

Once a synthesized frame sequence having the desired duration contour has been created, functions 920 and 922 modify the pitch of each frame 704 of the sequence 132A so as to more closely match the corresponding value of the pitch contour 1102 for that frame's corresponding portion of the duration contour.

In order to impose a new pitch upon a small set of adjacent LPC frame in the sequences to be synthesized, we need to change the spacing of the pulses indicated by the bits 33-42, 50-59, and 67-76 of each such LPC frame, shown in FIG. 8. These pulses are used to model vocal excitation in the LPC generated speech. We accomplish this change by setting the delay T to a spacing corresponding to the desired pitch for the set of frames and adding a series of pulses to a sequence of sub-frames that are positioned relative to each other so as to occur at a time T after each other. The recursive nature of the adaptive contribution will cause the properly spaced pulses to be copied on top of each other, so as to reinforce each other into a signal corresponding to the sound of glottal excitation. A positive sign gets assigned to all pulses to ensure that the desired reinforcement takes place. Because each sub-frame can only have exactly three pulses, we eliminate one of the original pulses for each sub-frame to which such a periodic pulse has been added.

We apply such pitch modification only to frames that model periodic, and thus probably voiced, segments in the speech signal. We use a binary decision to determine whether a frame is considered periodic or aperiodic. This decision is based on the average adaptive gain across all three sub-frames of a given frame. If its value exceeds 0.55, it is considered periodic enough to apply the pitch modification. However, if longer stretches of very high periodicity are encountered, as defined by at least 4 consecutive sub-frames with adaptive gains of at least 1, after such 4 consecutive sub-frames a period pulse is only added at a position corresponded to a delay of 3 times T. This is done to prevent the source signal from exhibiting excessive frame energies, because the adaptive and fixed contribution would otherwise constantly add up constructively.

Once the pitches of the sequence of LPC frames have been modified, as shown at 132B in FIG. 13, function 924 modifies the energy of each sub-frame to match the energy contour 1104 produced by the prosody output. In the embodiment shown this is done by multiplying the fixed gain value of each sub-frame by the square root of the ratio of the target energy (that specified by the energy contour) to the original energy of the sub-frame as it occurred in the original context from which the sub-frame's diphone snippet was recorded. Although not shown in the figures above, when the LPC encoding 700 shown in FIG. 7 is performed, it records the energy of the sound associated with each sub-frame. The set of such energy values corresponding to each sub-frame in a diphone snippet forms a energy contour for the diphone snippet that is also stored in the diphone snippet database in association with each diphone stored in that database. Function 924 accesses these snippet energy contours to determine the ratio between the target energy and the original energy for each sub-frame in the frame sequence.

It should be understood that the foregoing description and drawings are given merely to explain and illustrate the invention and that the invention is not limited thereto except insofar as the interpretation of the appended claims are so limited. Those skilled in the art who have the disclosure before them will be able to make modifications and variations therein without departing from the scope of the invention.

For example, the broad functions described in the claims below, like virtually all computer functions, can be performed by many different programming and data structures, and by using different organization and sequencing. This is because programming is an extremely flexible art form in which a given idea of any complexity, once understood by those skilled in the art, can be manifested in a virtually unlimited number of ways. To give just a few examples, in the pseudocode used in several of the figures of this specification the order of functions could be varied in certain instances by other embodiments of the invention.

It should be understood that the present invention is not limited to use on cellphones and that it can be used on virtually any type of computing device, including desktop computers, laptop computers, tablet computers, personal digital assistants, wristwatch phones, and virtually any other device in which text-to-speech synthesis is desired. But as has been pointed out above, the invention is most likely to be of use on systems which have relatively limited memory because it is in such devices that its potential to represent text-to-speech databases in a compressed form is most likely to be attractive.

It should also be understood that the text-to-speech synthesis of the present invention can be used for the synthesis of virtually any words, and is not limited to the synthesis of names. Such a system could be used, for example, to read e-mail to a user of a cellphone, personal digital assistants, or other computing device. It could also be used to provide text-to-speech feedback in conjunction with a large vocabulary speech recognition system.

In the claims that follow “linear predictive encoding” and “linear predictive decoder” are meant to refer to any speech encoder or decoder that uses linear prediction.

In the claims that follow claim limitations relating to the storage of data structures such as a phonetic spelling of pitch contour are meant to include even transitory storage used when such data structures are created on the fly for immediate use.

It should also be understood that the present invention relates to methods, systems, and programming recorded on machine readable memory for performing the innovations recited in this application.

What we claim is:

1. A method of performing text-to-speech synthesis comprising:
storing a plurality of encoded speech snippets, each including a sequence of one or more encoded sound representations produced by linear predictive encoding of speech sounds corresponding to a sequence of one or more phonemes, where a plurality of said snippets correspond to sequences of phonemes that are shorter than any of the words in which such a sequence of phonemes occurs;
storing a desired phonetic representation, indicating a sequence of phonemes to be generated as speech sounds; and
storing a desired pitch contour, indicating which of different possible pitch values are to be used in the generation of the speech sounds of different phonemes in the phonetic representation;
selecting from said stored snippets a sequence of such snippets that correspond to the sequence of phonemes in the phonetic representation and concatenating those snippets into a synthesized sequence of such snippets;
altering the encoded representations associated with one or more of the selected snippets associated with said synthesized sequence to cause the pitch values of the speech sounds represented by each such encoded representation to more closely match the pitch values indicated for the selected snippet's corresponding one or more phonemes in the pitch contour; and
using a linear predictive decoder to convert the synthesized sequences of snippets, including said altered snippets, into a waveform signal representing a sequence of speech sound corresponding to the phonetic representation and the pitch contour.

2. A method as in claim 1 further including generating said desired pitch contour from said desired phonetic representation or the text from which that phonetic representation corresponds before temporarily storing said pitch contour.

3. A method as in claim 1:
further including receiving a sequence of one or more words for which corresponding speech sounds are to be generated;
generating said desired phonetic representation as a sequence of one or more phonemes selected as probably representing the speech sounds associated with said received word sequence; and
generating said desired pitch contour from said desired phonetic representation before temporarily storing said pitch contour.

4. A method as in claim 1:
further including:
storing a plurality of encoded word snippets, each including a sequence of one or more encoded sound representations produced by linear predictive encoding of speech sounds corresponding to one or more whole words;
creating a sequence of speech sounds corresponding to a combination of encoded word snippets and said synthesized sequence of encoded snippets;
said using of the linear predictive decoder to convert the synthesized sequence of snippets includes converting both the synthesized sequence of snippets and the word snippets into corresponding speech sounds.

5. A method as in claim 1:
further including storing a desired duration contour, indicating which of different possible durations are to be used in the generation of the speech sounds of different phonemes in the phonetic representation; and
wherein said altering of the encoded representations of snippets includes altering such encoded representations to cause the duration of the speech sounds represented by each of the encoded representations to more closely match the duration indicated for the corresponding phonemes in the duration contour.

6. A method as in claim 5 further including generating a duration contour as an indication of the different possible durations to be used in the generation of the speech sound of the different phonemes in the phonetic representations,

7. A method as in claim 5 wherein:
said encoded representation represents speech sounds includes a sequence of frames, each of which represents a speech sound during a period of time; and
said altering of encoded representations to alter the duration of the speech sounds of encoded representations includes the insertion or deletion said frames from

8. A method as in claim 1:
further including storing a desired energy contour, indicating which of different possible energy levels are to be used in the generation of the speech sounds of different phonemes in the phonetic representation; and
wherein said altering of the encoded representations of snippets includes altering such encoded representations to cause the energy level of the speech sounds each of them represents to more closely match the energy values indicated for the corresponding phonemes in the pitch contour.

9. A method as in claim 8:
further including generating an energy contour as an indication of the different possible energy values to be used in the generation of the speech sound of the different phonemes in the phonetic representations;
wherein said altering of encoded representations associated with snippets associated with the synthesized sequence also includes altering said encoded representations to cause the energy values of the speech sounds each such encoded representation represents to more closely match the energy values indicated for the corresponding phonemes in the energy contour.

10. A method as in claim 1 wherein said method is performed on a cellphone.

11. A method as in claim 1 further including:
receiving sound corresponding to an utterance to be recognized;
generating an electronic representation of the utterance;
performing speech recognition against said electronic representation of the utterance to select as recognized one or more words as most likely to correspond to said utterance; and
responding to the selection of said recognized words by causing the desired phonetic representation used to select the snippets that are converted into the waveform signal to be a phonetic representation corresponding to said one or more recognized words.

12. A method as in claim 1 wherein said method is performed on a personal digital assistant.

13. A method as in claim 1 wherein said method is performed on a wrist phone.
